(19) United States
(12) Patent Application Publication
(10) Pub. No.: US 2026/0359467 A1
(43) Pub. Date: Nov. 12, 2026

(54) SYSTEM AND METHOD FOR SECURE FEDERATED ACCESS AND AUDITABLE SESSIONS FOR DATABASES

(71) Applicant: State Farm Mutual Automobile Insurance Company, Bloomington, IL (US)

(72) Inventors: Seemanth CHACKO, McKinney, TX (US); Taha KADADO, Sachse, TX (US); Jonathan HOCEVAR, Plano, TX (US)

(73) Assignee: State Farm Mutual Automobile Insurance Company, Bloomington, IL (US)

(21) Appl. No.: 19/277,940

(22) Filed: Jul. 23, 2025

Related U.S. Application Data
(60) Provisional application No. 63/800,818, filed on May 6, 2025.

(51) Int. Cl. G06F 21/62; G06F 21/60

(52) U.S. Cl. CPC G06F 21/6218; G06F 21/604; H04L 2463/082

(57) ABSTRACT

Systems and methods for providing temporary access to a remote database are disclosed. The method may include, such as by one or more processors, transceivers, and/or sensors: (1) authenticating a user via a federated identity provider that enforces multi-factor authentication; (2) determining a user access level based upon one or more user attributes received from the federated identity provider; (3) activating a cloud service identity and access management (IAM) role corresponding to the user access level obtained from the federated identity provider; (4) dynamically generating a set of temporary database credentials corresponding to the activated cloud service IAM role; and/or (5) establishing a secure connection to the remote database using the set of temporary database credentials.

### CROSS-REFERENCE TO RELATED APPLICATION

This patent application claims the benefit of priority to U.S. Provisional Application No. 63/800,818, filed on May 6, 2025, the entirety of which is incorporated herein by reference.

### TECHNICAL FIELD

This present disclosure relates generally to the field of secure access control for cloud-based database systems. In particular, the present disclosure relates to systems and methods for providing temporary, federated, and auditable access to database services.

### BACKGROUND

Conventional relational database services (RDS) may lack support for identity and access management (IAM)-based authentication mechanisms, including multi-factor authentication (MFA). This technical limitation may present a significant security and compliance challenge for organizations that need strong, identity-driven access control. Instead, these systems may rely on static username and password credentials, which may increase the risk of credential leakage, may provide limited access control, and/or may not accommodate temporary or rotating access for external partners. Moreover, managing credentials across multiple partner tenants may introduce operational complexity and may increase the likelihood of errors in credential provisioning, revocation, and/or auditing.

In conventional systems, credentials may be manually created and managed within each individual database instance, as there is no integration with a centralized identity provider (e.g., Entra ID or Lightweight Directory Access Protocol (LDAP)). This architecture may lack support for MFA, introducing potential security risks. Furthermore, when user roles or responsibilities change, updating or removing access may rely on manual intervention, which may be time-consuming, error-prone, and operationally inefficient, especially when consistent access control may be enforced across multiple database environments.

### SUMMARY

The present embodiments may relate, inter alia, to systems and methods for secure, federated access to managed relational database services, such as those discussed above and elsewhere herein. Specifically, the present computer systems and computer-implemented methods may solve technical challenges by dynamically provisioning temporary, role-based database credentials based upon federated identity, securely orchestrating access without persistent network exposure, and enabling full auditability through centralized logging and automated session control.

In one aspect, a computer-implemented method for providing temporary access to a remote database may be provided. The computer-implemented method may be implemented via one or more local or remote processors, servers, transceivers, memory units, mobile devices, voice bots or chatbots, ChatGPT bots, InstructGPT bots, Codex bots, Google Bard bots, and/or other electronic or electrical components, which may be in wired or wireless communication with one another and operate as input and/or output devices. In one instance, the computer-implemented method may be performed by one or more local or remote processors of a computing system in communication with one or more local or remote data sources.

The computer-implemented method may include, via one or more local or remote processors, transceivers, sensors, servers, and/or other components: (1) authenticating, via one or more processors, a user via a federated identity provider that enforces multi-factor authentication (MFA); (2) determining, via the one or more processors, a user access level based upon one or more user attributes received from the federated identity provider; (3) activating, via the one or more processors, a cloud service identity and access management (IAM) role corresponding to the user access level obtained from the federated identity provider; (4) dynamically generating, via the one or more processors, a set of temporary database credentials corresponding to the activated cloud service IAM role; and/or (5) establishing, via the one or more processors, a secure connection to the remote database using the set of temporary database credentials. The method may include additional, less, or alternate functionality, including that discussed elsewhere herein.

In another aspect, a computer system for providing temporary access to a remote database may be provided. The computer system may be implemented via one or more local or remote processors, servers, transceivers, memory units, mobile devices, voice bots or chatbots, ChatGPT bots, InstructGPT bots, Codex bots, Google Bard bots, and/or other electronic or electrical components, which may be in wired or wireless communication with one another. In one instance, the computer system may be performed by one or more local or remote processors of a computing system in communication with one or more local or remote data sources, and at least one non-transitory computer readable medium storing instructions which, when executed by the one or more processors, cause the one or more processors to perform certain operations.

The computer system may include, via one or more processors, non-transitory computer readable medium, transceivers, sensors, servers, and/or other components to perform operations that may include: (1) authenticating a user via a federated identity provider that enforces MFA; (2) determining a user access level based upon one or more user attributes received from the federated identity provider; (3) activating a cloud service IAM role corresponding to the user access level obtained from the federated identity provider; (4) dynamically generating a set of temporary database credentials corresponding to the activated cloud service IAM role; and/or (5) establishing a secure connection to the remote database using the set of temporary database credentials. The system may include additional, less, or alternate functionality, including that discussed elsewhere herein.

In yet another aspect, a non-transitory computer readable medium for providing temporary access to a remote database may be provided. The non-transitory computer readable medium may be implemented via one or more local or remote processors, servers, transceivers, memory units, mobile devices, voice bots or chatbots, ChatGPT bots, InstructGPT bots, Codex bots, Google Bard bots, and/or other electronic or electrical components, which may be in wired or wireless communication with one another. In one instance, the non-transitory computer readable medium may be performed by one or more local or remote processors of a computing system in communication with one or more local or remote data sources, and at least one non-transitory computer readable medium storing instructions which, when executed by the one or more processors, cause the one or more processors to perform certain operations.

The non-transitory computer readable medium may include, via one or more processors, transceivers, sensors, servers, and/or other components: (1) authenticating a user via a federated identity provider that enforces MFA; (2) determining a user access level based upon one or more user attributes received from the federated identity provider; (3) activating a cloud service IAM role corresponding to the user access level obtained from the federated identity provider; (4) dynamically generating a set of temporary database credentials corresponding to the activated cloud service IAM role; and/or (5) establishing a secure connection to the remote database using the set of temporary database credentials. The operations may include additional, less, or alternate functionality, including that discussed elsewhere herein.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 depicts a diagram showing an exemplary architecture for providing temporary, federated, and/or policy-based access to a remote database, according to certain aspects of the disclosure.

FIG. 2 is an exemplary flowchart of a computer-implemented or computer-based process for providing secure and temporary access to the remote database using federated identity with MFA and automated credential provisioning based on cloud service role attributes, according to one or more embodiments.

FIG. 3A illustrates an exemplary diagram of secure federated access patterns to RDS via dynamic session orchestration, according to one or more embodiments.

FIG. 3B illustrates an exemplary diagram of a secure, automated workflow for providing temporary access to a managed relational database using federated authentication, just-in-time user provisioning, and centralized audit logging, according to one or more embodiments.

FIG. 3C illustrates a user interface 341 for providing secure, federated access to remote databases while ensuring user activity is auditable, according to one or more embodiments.

FIG. 4 illustrates an implementation of an exemplary computer system that executes one or more techniques presented herein.

Advantages will become more apparent to those skilled in the art from the following description of the preferred embodiments that have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

The present embodiments may relate, inter alia, to computer systems and computer-implemented methods that may solve technical challenges by enabling secure, automated, and temporary access to cloud-hosted relational database service through federated identity with multi-factor authentication (MFA), dynamic access-level determination, and/or on-demand credential provisioning. Unlike conventional systems that rely on static database users, manual role assignments, and/or lack integrated identity controls, the present embodiments introduce a centralized automation layer that may map user identity attributes to cloud IAM roles, provision temporary credentials, and/or establish secured, monitored sessions. Such approaches may reduce administrative overhead, enhance security through credential isolation and lifecycle control, and/or provide full auditability of access events, thereby aligning with the principle of least privilege in modern cloud environments.

Conventional methods of managing access to databases, particularly in cloud-hosted environments, such as RDS, may rely on static user credentials and manual provisioning. These approaches may introduce a range of security, operational, and/or compliance challenges. For example, the RDS may lack the ability to provide native support for federated authentication or integration with enterprise identity providers. As a result, user identities may be recreated and maintained manually within each database instance, creating a fragmented identity layer that is difficult to manage and scale. Furthermore, there is no built-in support for MFA, leaving organizations with limited options for enforcing strong authentication policies at the database level.

When roles or responsibilities change, such as DBA moves to a different team or project, access may be manually revoked, which often leads to delays or oversight. Static credentials are typically long-lived and prone to being shared, reused, or forgotten, increasing the risk of unauthorized access. This may make it challenging to implement just-in-time access or temporary elevation, both of which are critical for enforcing the least privilege principles. Furthermore, auditing and traceability are limited, as traditional access mechanisms often do not produce end-to-end logs that correlate cloud identity, access context, and database activity. These gaps may significantly hinder compliance efforts, especially in regulated environments requiring detailed access tracking, session expiry, and role-based access enforcement.

### Exemplary Computer system for Federated, Time-Bound Access to Cloud-Hosted Relational Databases

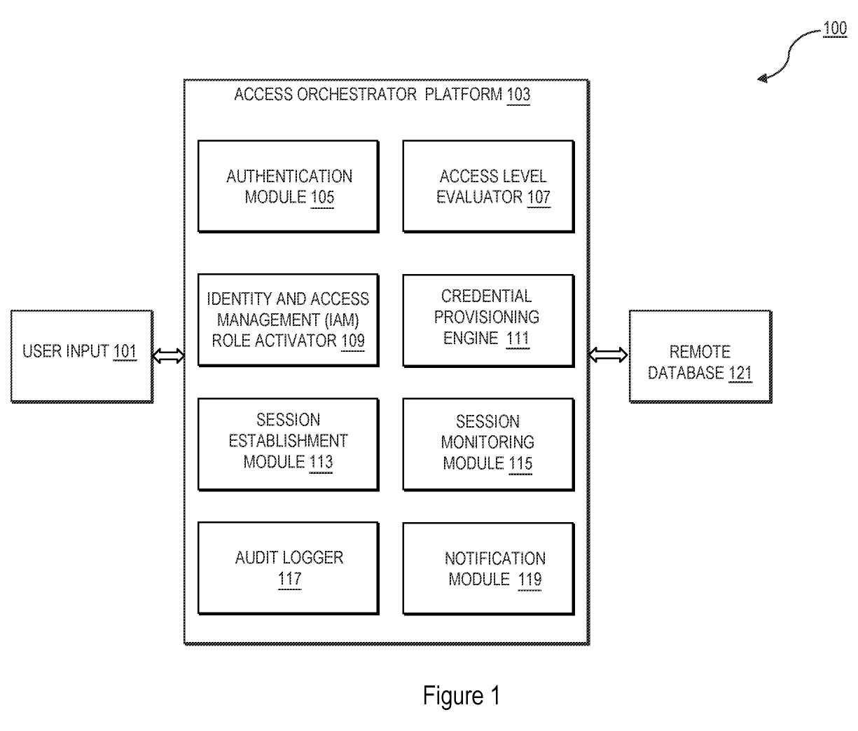

To address technical challenges, such as the above, system 100 of FIG. 1 may introduce an automated, federated access control mechanism that may enable secure, temporary, and auditable access to databases hosted on a managed relational database service (e.g., RDS). By leveraging federated identity providers (e.g., Entra ID) and enforcing multi-factor authentication (MFA) at the entry point, the system 100 may eliminate the need to manually manage user identities and passwords within the database. Upon successful authentication, the system 100 may dynamically map user attributes to predefined access levels and may activate a corresponding cloud identity and access management (IAM) role. This IAM role may drive the generating of temporary database credentials, which may be securely injected into a time-bound session, without direct exposure to the user. The entire process may be orchestrated through an automation layer that may provision ephemeral infrastructure (e.g., a jump server or secure proxy), establish database connection on behalf of the user, and monitor the session activity.

The system 100 may improve upon traditional methods by eliminating static credentials, reducing the administrative overhead of manual user management, and/or enforcing a least-privilege, just-in-time access model. Unlike traditional systems that may rely on persistent accounts and untracked manual logins, the system 100 may provide end-to-end traceability, from federated user authentication to session termination, through centralized login and audit trails. Such automation may ensure that access is granted only when needed and revoked immediately after use of inactivity, significantly reducing the window of potential misuse. By integrating access policies, identity context, and/or credential lifecycle management into a single platform, the system 100 may enable secure, scalable, and/or compliant database access workflows.

FIG. 1 depicts a diagram showing an exemplary architecture for providing temporary, federated, and/or policy-based access to a remote database, according to certain aspects of the disclosure. FIG. 1 may include the computing system 100 that may include a user input 101, an access orchestrator platform 103, and a remote database 121. It should be understood that other implementations of computing system 100 may omit one or more of the foregoing components and/or may include additional components, as the case may be.

In one instance, the user input 101 may include a request to access a protected database system (e.g., remote database 121). The user input 101 may be provided through a web-based interface, command-line tool, or API. The user input may include the user’s credentials (e.g., username or email address) and may also include contextual parameters, such as target database identifier, the desired access level (e.g., read-only or administrative), and the justification or purpose for access. These inputs may serve as the basis for initiating authentication and determining access policies.

In one example, the users may use their devices for user input 101. The user device may include a smartphone, a tablet, a desktop or laptop computer, voice-enabled smart assistants, or any portable electronic device capable of communicating with external systems. Each device may provide different interaction modalities, such as touch, keyboard, voice, or gesture, enabling users to engage with the system 100 in the preferred format. The user device may include various applications, such as, but not restricted to, networking applications, software applications, content provisioning applications, multimedia applications, camera/imaging applications, notification services, application services, storage services, contextual information determination services, location-based services, social networking services, and the like.

In one instance, the access orchestrator platform 103 may include a platform with multiple interconnected components. The access orchestrator platform 103 may include one or more servers, intelligent networking devices, computing devices, components, and/or corresponding software for providing temporary access between federated users and remote database instances in a cloud environment. The access orchestrator platform 103 may act as an intermediary layer that may authenticate users through an external identity provider enforcing MFA, evaluate user attributes to determine access level, and/or dynamically provision the necessary infrastructure and credentials to establish a secure connection to the database. The access orchestrator platform 103 may support fully automated policy-driven access management and may ensure that access decisions and actions are executed based upon federated identity attributes, ensuring a consistent and centralized access control strategy.

The access orchestrator platform 103 may coordinate the entire session lifecycle, from IAM role activation to the timed revocation of temporary database credentials. By handling credential injections, secure session creation, and activity monitoring, the access orchestrator platform 103 may ensure that elevated access is auditable and time-bound. The access orchestrator platform 103 may maintain comprehensive logging and auditing of all operations to meet compliance and traceability requirements, and may integrate seamlessly with GUI-based database tools while abstracting away infrastructure complexity from the users. This architecture may enable service providers to implement zero-trust principles for database access without modifying underlying database engines or compromising usability.

In one instance, the access orchestrator platform 103 may include an authentication module 105, an access level evaluator 107, an identity and access management (IAM) role activator 109, a credential provisioning engine 111, a session establishment module 113, a session monitoring module 115, an audit logger 117, a notification module 119, or any combination thereof. As used herein, terms such as “component” or “module” generally encompass hardware and/or software, e.g., that a processor or the like used to implement associated functionality. It is contemplated that the functions of these components are combined in one or more components or performed by other components of equivalent functionality.

In one instance, the authentication module 105 may validate the identity of users attempting to access the remote databases (e.g., remote database 121). The authentication module 105 may integrate with a federated identity provider (IdP), such as Entra ID, and may enforce MFA as a need for access. Upon successful authentication, the authentication module 105 may retrieve identity attributes and metadata from the IdP, such as user roles, group memberships, security clearance, and/or department, which may be utilized to determine the user’s authorization level in downstream modules. The authentication module 105 may ensure that only authenticated users initiate the session request, and may log all authentication attempts for audit purposes.

In one instance, the access level evaluator 107 may interpret identity attributes obtained from the IdP and may map the attributes to predefined access levels or entitlements within the system. These mappings may be governed by configurable policies that may align with organizational access control standards, ensuring that users are granted the minimum necessary privileges. The access level evaluator 107 may support integration with external policy engines (e.g., Open Policy Agent) and may apply dynamic context-based rules, such as time of access or geographic location, to further refine access levels. By translating identity context into actionable access levels, the access level evaluator 107 may enforce fine-grained, attribute-based access control and may ensure that elevated privileges are issued under appropriate and auditable conditions.

In one instance, the IAM role activator 109 may securely assume a cloud-native IAM role that corresponds to the access level determined by the access level evaluator 107. Using the mapped access tier, the IAM role activator 109 may initiate a temporary role assumption through the cloud provider’s security token service, generating time-bound credentials that encapsulate the permissions needed for database session initiation. The IAM role activator 109 may ensure that the assumed role is scoped according to least-privilege principles, granting only the specific actions necessary for the current session. In addition, the IAM role activator 109 may log all activities related to role activation, enforce maximum session duration, and tag the session for audit traceability.

In one instance, the credential provisioning engine 111 may generate and manage temporary database credentials that are tightly bound to the IAM role assumed by the IAM role activator 109. Upon receiving the session context and authorization level, the credential provisioning engine 111 may use a privileged service account to connect to the target database (e.g., remote database 121) instance and programmatically create a temporary database user with scoped privileges and a securely generated password. These credentials may be time-limited and exist for the duration of the active session. The credential provisioning engine 111 may ensure that the credentials are encrypted in transit and at rest, and are injected directly into the secure session channel. Additionally, all credential creation and usage events may be logged for auditability.

In one instance, the session establishment module 113 may initiate a secure connection to the target database (e.g., remote database 121) using the temporary credentials provisioned by the credential provisioning engine 111. The session establishment module 113 may manage the connection by using a secure proxy or temporary jump server, which may act as an intermediary between the user’s client application and the database. The session establishment module 113 may inject the credentials directly into the session context, allowing users to connect via GUI-based tools without exposing the credentials. The session establishment module 113 may support standard connection protocols and may enforce encryption for all traffic. Additionally, the session establishment module 113 may record the session metadata (including user identity, access level, time stamp, and target database) for real-time monitoring and audit logging.

In one instance, the session monitoring module 115 may continuously track the status, duration, and/or behavior of each user session. The session monitoring module 115 may operate on configurable policies to detect inactivity, misuse, or expiration, using either time-based polling, event triggers, or integration with the database’s native session tracking mechanisms. If a session exceeds a predefined threshold, such as idle timeout or maximum allowed duration, the session monitoring module 115 may trigger an automated revocation workflow that may terminate the session, remove the temporary database user, and/or decommission any cloud resources provisioned for the access (e.g., jump server or secure proxy). The session monitoring module 115 may also stream session activity logs to a centralized logging service for compliance and security audits. The session monitoring module 115 may enforce just-in-time access boundaries, ensuring that temporary access is both time-bound and purpose-limited.

In one instance, the audit logger 117 may capture a complete record for all user and system activities, such as authentication events, access level resolutions, IAM role assumptions, credential provisioning actions, session initiation and terminations, and/or any anomalies detected during session monitoring. The audit logger 117 may enrich the logs with metadata (e.g., user identity, timestamp, role mappings, database targets, and/or IP addresses) to support detailed auditing and compliance. The audit logger 117 may ensure that every access request is fully traceable end-to-end, in alignment with organizational security policies and regulatory needs.

In one instance, the notification module 119 may generate real-time alerts and status updates to relevant stakeholders throughout the access lifecycle. This may include notifications for events, such as successful or failed authentication, IAM role activation, temporary credential issuance, session start and end times, and/or forced session terminations due to timeout or policy violations. The notifications may support escalation logic and customizable thresholds to highlight unusual behavior, such as repeated failed access attempts or unusually long sessions. By providing timely and actionable visibility, the notification module 119 may play a critical role in enforcing real-time accountability.

In one instance, the remote database 121 is a target database (e.g., a managed RDS instance) hosted in a cloud environment, typically within a secure, network-isolated virtual private cloud (VPC). This database may include the data assets that the user (e.g., a database administrator) is authorized to access under strict, time-bound, and role-based conditions. Direct access to the remote database 121 may be tightly controlled, for example, the remote database 121 does not expose native interfaces to end users without first passing through the platform’s secure session orchestration process. The remote database 121 may support multiple schemas, users, and/or roles, and may be governed by standard relational database access control mechanisms. The remote database 121 may be designed to remain highly available, scalable, and/or compliant with organizational data retention and backup policies. As a managed cloud database, administrative access to the remote database 121 may be intentionally restricted and configured to support enterprise-grade logging, encryption, and/or monitoring capabilities.

The various elements of the computing system 100 may communicate with each other through a communication network. In one instance, a user device (e.g., a smartphone, a tablet, a desktop or laptop computer, voice-enabled smart assistants, or any portable electronic device capable of communicating with external systems) may include a network detection sensor for detecting wireless signals or receivers for different communications (e.g., Bluetooth, Wi-Fi, Li-Fi, near field communication (NFC), etc.) from the communication network. The communication network may support a variety of different communication protocols and communication techniques.

In one instance, the communication network may allow the user device to communicate with the access orchestrator platform 103. The communication network may include one or more networks such as a data network, a wireless network, a telephony network, or any combination thereof. It is contemplated that the data network is any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network is, for example, a cellular communication network and employs various technologies including 5G (5th Generation), 4G, 3G, 2G, Long Term Evolution (LTE), wireless fidelity (Wi-Fi), Bluetooth®, Internet Protocol (IP) data casting, satellite, mobile ad-hoc network (MANET), vehicle controller area network (CAN bus), and the like, or any combination thereof.

The above presented modules and components of the access orchestrator platform 103 may be implemented in hardware, firmware, software, or a combination thereof. Though depicted as a separate entity in FIG. 1, it is contemplated that the access orchestrator platform 103 may be implemented for direct operation by the respective user device. As such, the access orchestrator platform 103 may generate direct signal inputs by way of the operating system of the user device. In one instance, one or more of the modules 105-119 may be implemented for operation by the respective user device, as the access orchestrator platform 103. The various executions presented herein contemplate any and all arrangements and models.

### Exemplary Flowchart for Providing Temporary Access to a Remote Database

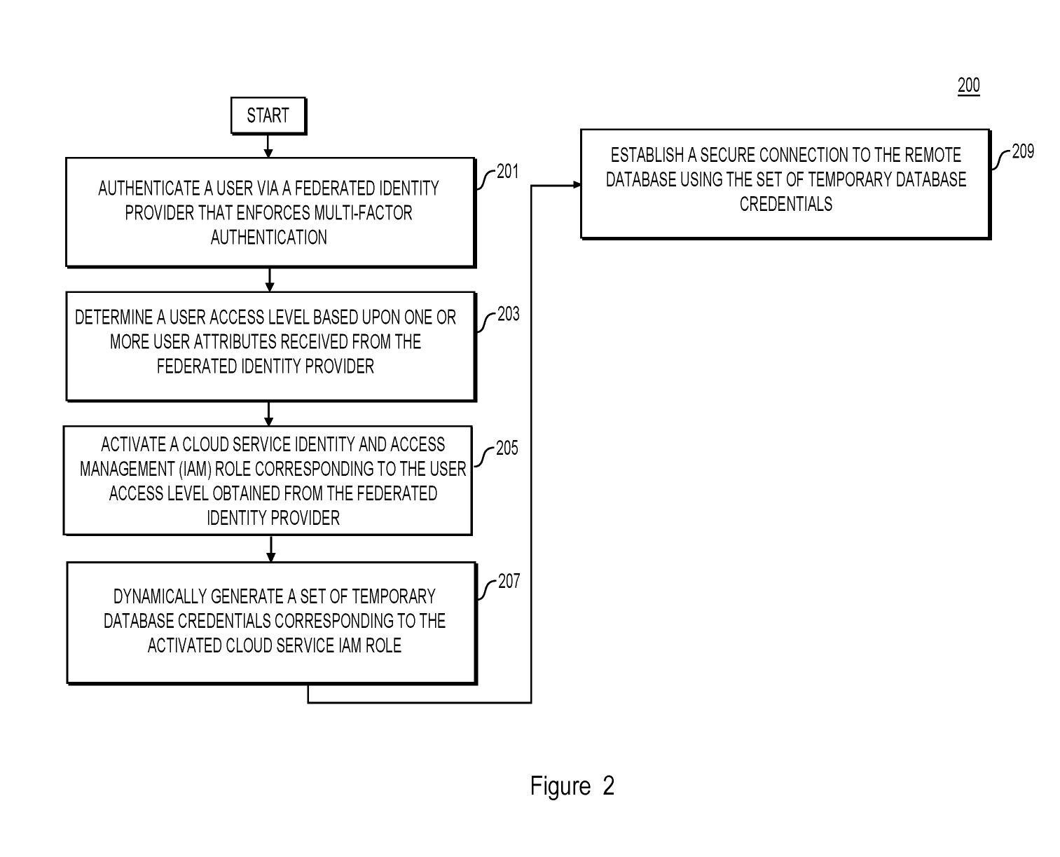

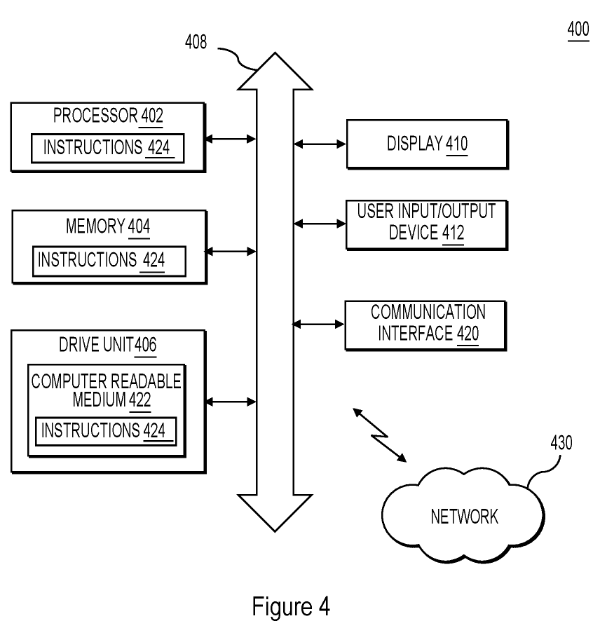

FIG. 2 is an exemplary flowchart of a computer-implemented or computer-based process for providing secure and temporary access to the remote database (e.g., remote database 121) using federated identity with MFA and automated credential provisioning based on cloud service role attributes, according to one or more embodiments. In one instance, the access orchestrator platform 103 and/or any of the modules 105-119 may perform one or more portions of the process 200 and are implemented using, for instance, a chip set including a processor (e.g., processor 402) and a memory (e.g., memory 404), as shown in FIG. 4. As such, the access orchestrator platform 103 and/or any of the modules 105-119 may be configured to facilitate accomplishing various parts of the process 200, as well as accomplishing embodiments of other processes described herein in conjunction with other components of the computing system 100. Although the process 200 is illustrated and described as a sequence of actions, operations, and/or functionality, it is contemplated that various embodiments of the process 200 may be performed in any order or combination and need not include all of the illustrated actions, operations, and/or functionality.

In block 201, the access orchestrator platform 103 may authenticate a user via a federated identity provider that enforces MFA. In one example, the access orchestrator platform 103 may receive an authentication request from the user, and the received request may be forwarded to the federated identity provider, an external system that may manage digital identities and provide authentication services across multiple systems using standardized protocols. The federated identity provider may enforce MFA by requesting that the users provide multiple forms of verification. Upon successful authentication, the federated identity provider may generate a federated token that may include user attributes. In one instance, the user attribute(s) may include (i) a group membership attribute, (ii) a role designation attribute, (iii) a security classification attribute, and/or (iv) an organizational unit designation attribute.

In block 203, the access orchestrator platform 103 may determine a user access level based upon user attribute(s) received from the federated identity provider. In one instance, the access orchestrator platform 103 may evaluate the user attributes and map the user attributes to a predefined access policy that specifies the corresponding privileges or access tier within the cloud environment.

In block 205, the access orchestrator platform 103 may activate a cloud service IAM role corresponding to the user access level obtained from the federated identity provider. In one instance, the cloud service IAM role may define least-privilege access permission(s) to the remote database. The least-privilege access permissions may be limited to actions necessary for connecting to the remote database and managing the set of temporary database credentials. In one instance, the user access level may determine a set of database permissions assigned to the cloud service IAM role corresponding to the user access level.

In block 207, the access orchestrator platform 103 may dynamically generate a set of temporary database credentials corresponding to the activated cloud service IAM role. The set of temporary database credentials may be created automatically by a script that executes when the user successfully authenticates. The automated script may be configured to interface with the remote database to generate the set of temporary database credentials with one or more predefined access permissions and expiration policies.

In one instance, the set of temporary database credentials may have a predefined time-to-live (TTL) that may be dynamically determined based upon the cloud service IAM role such that users with different cloud service IAM roles may be granted temporary access for varying durations. In one instance, the predefined TTL may refer to a duration after which the temporary database credentials automatically expires, ensuring that access is limited to a specific time window. The set of temporary database credentials may be encrypted during transmission from credential provisioning to a secure session interface. The encrypted credentials may be provided to the secure session interface configured to establish a connection to the remote database.

In one instance, the access orchestrator platform 103 may monitor user session activity in the remote database. The access orchestrator platform 103 may identify an occurrence of a predetermined event, such as (i) a user activity has not been detected within a predetermined timeout interval, (ii) a predefined TTL is reached, and/or (iii) a logout signal was initiated by the user or a system. The access orchestrator platform 103 may revoke the set of temporary database credentials based upon the identification of the predetermined event. Such revoking of the set of temporary database credentials may trigger the deprovisioning of one or more cloud resources created during the user session activity.

In block 209, the access orchestrator platform 103 may establish a secure connection to the remote database using the set of temporary database credentials. The access orchestrator platform 103 may generate a notification in a device associated with the user upon successful session initiation or session termination. The access orchestrator platform 103 may log at least a subset of events and/or actions associated with the session activity in an auditable format. The logged subset of events and/or actions may be transmitted over a secure channel and stored in an access-controlled, encrypted storage bucket (e.g., S3 buckets).

### Exemplary Federated Access and Tunnel-Based Database Connectivity Diagram

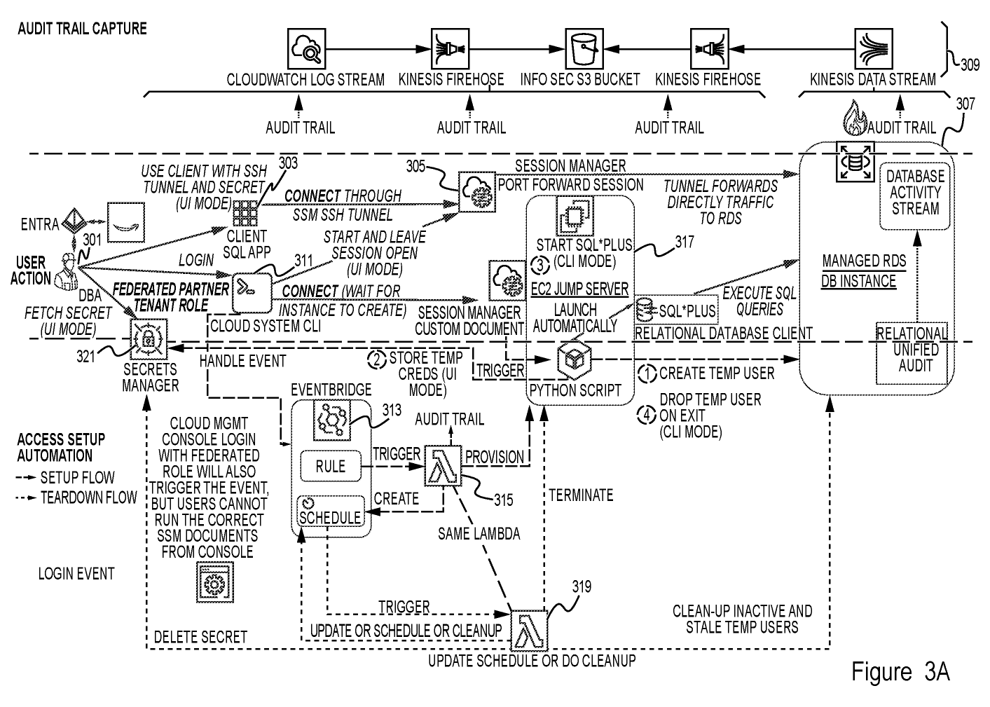

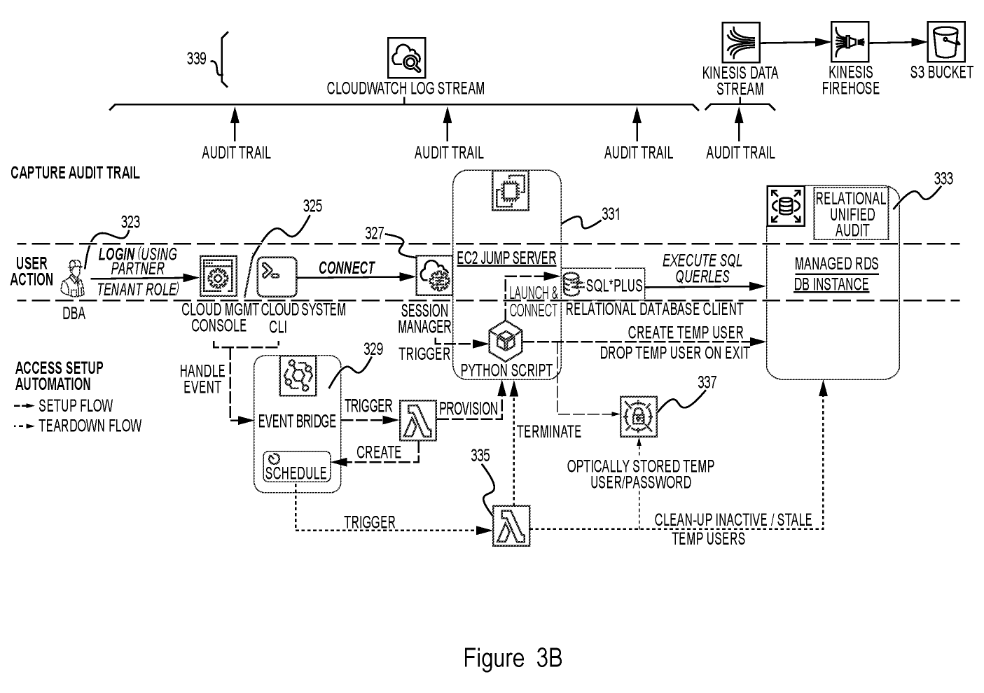

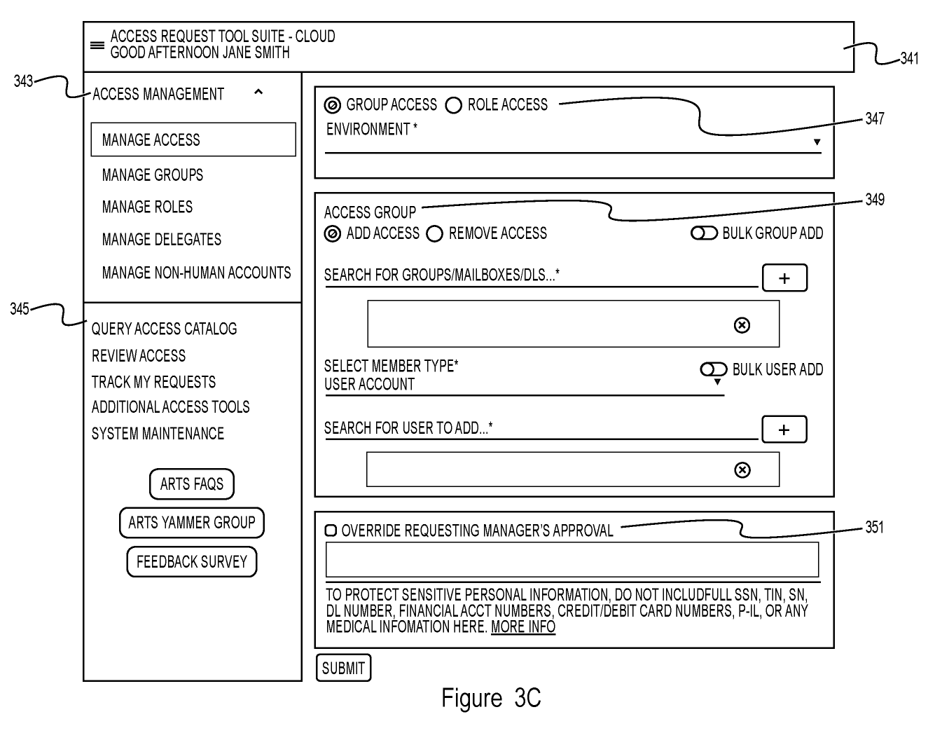

FIG. 3A illustrates an exemplary diagram of secure federated access patterns to RDS via dynamic session orchestration, according to one or more embodiments. FIG. 3A includes horizontal flows 1, 2, and 3, as discussed below:

### Horizontal Flow 1

In one instance, a user 301, typically a database administrator (DBA), may communicate with the access orchestrator platform 103 to initiate a connection to a RDS database (e.g., remote database 121). The access orchestrator platform 103 may authenticate the user 301 via a federated identity provider (e.g., Entra ID) which may enforce multi-factor authentication (MFA). Upon successful authentication, the access orchestrator platform 103 may intercept the identity assertion and evaluate user attributes to determine access entitlement and roles. The access orchestrator platform 103 may activate a cloud identity and access management (IAM) role corresponding to the user’s approved access level.

In step 303, the user interface (UI) mode of the client application may provide a seamless interaction layer, often leveraging a secure shell (SSH) tunnel. This tunnel may securely transmit data and/or retrieve dynamic secrets from a secure credential store, enabling just-in-time access with no exposure to long-lived credentials.

In step 305, the access orchestrator platform 103 may initiate a secure port-forwarding session by orchestrating a cloud systems manager (SSM). This session may provide a secure channel between the user’s client and the RDS database, without relying on any inbound network access or permanent network exposure. The access orchestrator platform 103 may programmatically launch the SSH tunnel that may forward traffic from the user’s local client through an ephemeral compute instance, effectively bridging the gap between the user environment and the database within a private subnet. This configuration may eliminate the need for VPN access or permanent firewall rules, while still enforcing enterprise-grade security controls.

In step 307, as part of the session setup, the access orchestrator platform 103 may generate a set of temporary, encrypted database credentials scoped to the assumed IAM role. These credentials may be securely injected into the session environment, and the secure tunnel established by SSM may allow the user to interact with the RDS database as though it were accessible on the local network. This may include running SQL queries, performing administrative operations, and/or using GUI tools like SQL developer. Despite this seemingly direct access, all traffic may remain securely isolated within the environment. Additionally, every session initiated through SSM may be logged, enabling real-time visibility into session activity, connection duration, and/or actions performed within the database environment.

In step 309, the access orchestrator platform 103 may stream session activity data into a centralized logging pipeline to ensure complete auditability and compliance. For example, a stream log may capture detailed session metadata, which is then processed through various systems (e.g., Kinesis Firehose). From there, the data may be streamed to an information security-controlled bucket for long-term retention, analysis, and/or audit. This architecture may ensure that every connection, credential issuance, and/or database interaction may be monitored and logged, supporting rigorous security policies and regulatory compliance frameworks.

### Horizontal Flow 2

In step 311, the user 301 may log-in to their enterprise identity providers, which may be federated with a cloud system (e.g., AWS or other web services) using a partner tenant role managed through an enterprise identity provider (e.g., Microsoft Entra ID or other federated identity providers). This role may establish a federated trust relationship between the user’s identity and the cloud environment, enabling secure access without managing native cloud system credentials. Upon successful login, the federated session may grant the user a temporary and scoped IAM role that may align with the user’s entitlements and access policies.

In steps 313 and 315, the access orchestrator platform 103 may invoke an event-driven rule in the cloud system (e.g., AWS EventBridge rule) that may provision an audit trail entry and optionally create a scheduled task for session lifecycle management. This rule may trigger a workflow that may include logging the access request, starting time-bound audit sessions, and/or scheduling future events. In step 317, once authenticated, the access orchestrator platform 103 may initiate a session via the cloud system command line interface (CLI). During this process, the access orchestrator platform 103 may launch a secure environment using cloud systems manager (SSM), often involving the dynamic provisioning of a temporary EC2 instance (e.g., jump server). A session manager custom document may be utilized to initialize and manage the session. Upon connectivity to the jump server, the access orchestrator platform 103 may launch SQL*Plus or another relational database-compatible client in CLI mode.

The access orchestrator platform 103 may handle the automatic generation of short-lived relational database credentials tied to the IAM role and user identity, scoped to the user’s assigned privileges. These credentials may be injected securely into the client environment, enabling direct database interaction without exposing the actual password. The user 301 can then perform administrative tasks or run SQL queries against the managed RDS instance, all within a controlled, auditable, and/or time-bound session. When the session ends or exceeds its time-to-live (TTL), the credentials are revoked, and the EC2 instance is terminated. For example, in step 319, based upon the schedule, the access orchestrator platform 103 may automatically update the session state, extend access if conditions permit, or trigger a cleanup workflow. The cleanup process may identify inactive sessions and may systematically revoke temporary users, ensuring no unused credentials persist beyond their intended duration.

Alternatively, the user may initiate the secure port-forwarding session using the SSM session manager, keeping the session open to securely forward database traffic to the cloud-based managed RDS database. The access orchestrator platform 103 may programmatically launch the SSH tunnel that may forward traffic from the user’s local client through an ephemeral compute instance. This process is similar to the process discussed in horizontal flow 1 and is not discussed in detail.

### Horizontal Flow 3

In step 321, the user 301 may initiate a request to connect to the cloud-based managed RDS database through a client operating in UI mode. The user may be authenticated via an enterprise identity provider, which may enforce MFA and may validate the user’s identity through federation with the cloud system. This federation may assign a temporary, scoped cloud IAM role through the partner tenant model. Once the authentication is complete, the access orchestrator platform 103 may trigger a connection workflow. The access orchestrator platform 103 may initiate a secure process to fetch dynamically generated, short-lived credentials from cloud-based secrets managers. These credentials may be tied to the user’s IAM role and may be crafted based upon policy-driven access control rules, ensuring the principle of least privilege.

As this retrieval occurs, the access orchestrator platform 103 may invoke the event-driven rule in the cloud system, which may trigger a workflow that includes logging the access request, starting a time-bound audit session, and/or optionally scheduling automatic credential expiration (as discussed in horizontal flow 2). This may ensure that all database access is controlled and traceable, with centralized auditing triggered at the moment of credential access. Following credential generation, the access orchestrator platform 103 may launch an EC2 jump server configured for secure access via the cloud systems manager (SSM). Using a custom automation document, the access orchestrator platform 103 may provision the environment and start a CLI-based relational database client, such as SQL*Plus. A background Python script securely injects the temporary credentials into the session, enabling the user 301 to run SQL queries or perform administrative actions. Throughout the session, all actions are monitored and logged. Once the session concludes or exceeds its predefined TTL, the access orchestrator platform 103 may ensure credentials are revoked and the jump server is automatically decommissioned.

### Exemplary Federated Access Control and Session Automation Diagram

FIG. 3B illustrates an exemplary diagram of a secure, automated workflow for providing temporary access to a managed relational database using federated authentication, just-in-time user provisioning, and centralized audit logging, according to one or more embodiments.

In one instance, a user 323, typically a DBA, may log into the cloud management console using a federated identity via a partner tenant (step 325). The authentication may be managed through the enterprise identity provider, which may enforce MFA and identity governance. Once authenticated, the user may assume a temporary cloud IAM role defined within the partner tenant, which may grant scoped permissions necessary to initiate secure operations within the cloud environment. This authentication process may be orchestrated and tracked by the access orchestrator platform 103, which may act as the policy and workflow layer between user identity and cloud resource access.

From the cloud management console or using cloud service provider CLI, the access orchestrator platform 103 may facilitate two possible interaction paths. In the first path, the user 323 may directly initiate a secure session with the cloud session manager, allowing the user 323 to connect to a pre-authorized EC2 jump server without relying on SSH key pairs or inbound access (step 327). In the second path, the access orchestrator platform 103 may trigger an event-driven rule in the cloud system based upon the user’s session initiation (step 329). This EventBridge rule may trigger a workflow that may include logging the access request, starting a time-bound audit session, and/or scheduling automatic credential expiration. The session may remain valid and active for a defined duration, governed by IAM session timeouts.

In step 331, once the EC2 instance is launched, the access orchestrator platform 103 may execute a Python-based automation script on the jump server. The script may use SQL*Plus or client libraries to connect to the cloud-based managed RDS instance and provision a time-limited user account. In step 333, with the temporary database user in place, the user 323 may execute SQL queries against the cloud-based managed RDS database instance using their client tool of choice. The EC2 jump server may act as a tightly controlled intermediary, enabling secure access to the database environment without direct exposure of credentials or the need for permanent firewall rules. During this process, all access and actions may be monitored and governed by the access orchestrator platform 103. Upon session termination, or after detecting a period of inactivity, the access orchestrator platform 103 may execute a clean-up routine that drops the temporary user and deletes any stale or inactive accounts that may pose a security risk (steps 335 and 337).

In step 339, the access orchestrator platform 103 may log user interactions (e.g., session initiation, credential provisioning, database actions, and cleanup events) in real-time. The cloud logging service (e.g., AWS CloudWatch Logs or other logging services) may capture these events and stream them into a centralized telemetry pipeline using real-time data streaming services (e.g., Kinesis Data stream and Kinesis Firehose). The logs may be delivered to the S3 bucket, where they are stored for long-term audits.

### Exemplary Access Management Interface

FIG. 3C illustrates a user interface 341 for providing secure, federated access to remote databases (e.g., remote database 121) while ensuring user activity is auditable, according to one or more embodiments. In one instance, the access orchestrator platform 103 may generate the user interface 341 that may provide a centralized platform where administrators may manage access permissions across a distributed, cloud-based infrastructure. It may include comprehensive access management that may allow authorized users to manage individual access rights, user groups, role-based permissions, delegate assignments, and/or federate accounts.

In this example, the user interface 341 may include an access management tab 343. The access management tab 343 may provide centralized control over user access rights across federated systems. It may allow administrators to (i) view and modify individual or group-based access entitlements, (ii) create, edit, and delete access groups aligned with roles or departments, (iii) assign or revoke delegate access for administrative or functional responsibilities, and/or (iv) administer service accounts, bots, or integration identities with appropriate controls.

The user interface 341 may include a query access catalog 345 that may search the access catalog for roles, entitlements, and policy definitions. The query access catalog 345 may allow users and administrators to (i) review historical access changes or monitor pending approvals, (ii) track request statuses in real-time, (iii) advanced potions for bulk actions, import/export functions, or conditional access setups, and/or (iv) tools for system administrators to maintain configurations.

The user interface 341 may also include group access and role access tab 347 that may enable users and administrators to explore and manage access at a broader level by examining predefined group or role configurations. This may simplify access control across large user populations and may support policy-driven access governance in federated environments.

The user interface 341 may further include access group tab 349 that may enable dynamic updates to group-level access privileges, allowing administrators to add or remove users from access groups (e.g., in real-time). The access group tab 349 may provide a granular interface for modifying group access profiles, while also maintaining an audit log of changes, for security and traceability.

The user interface 341 may also include override requesting manager’s approval tab 351 that may allow designated personnel to override a requesting manager’s approval in specific scenarios, such as policy exceptions or emergency access needs.

The user interface 341 may enable secure, centralized, and auditable access management across federated systems, reducing administrative overhead and ensuring compliance with access policies.

### Exemplary Computing Environment

In general, any process or operation discussed in this disclosure is understood to be computer-implementable, such as the processes illustrated in FIGS. 1-3C and may be performed by one or more processors of a computer system as described herein. A process or process action or operation performed by one or more processors may also be referred to as an operation. The one or more processors may be configured to perform such processes by having access to instructions (e.g., software or computer-readable code) that, when executed by one or more processors, cause the one or more processors to perform the processes. The instructions may be stored in a memory of the computer system. A processor may be a central processing unit (CPU), a graphics processing unit (GPU), or any suitable type of processing unit.

A computer system, such as a system or device implementing a process or operation in the examples above, may include one or more computing devices. One or more processors of a computer system may be included in a single computing device or distributed among a plurality of computing devices. One or more processors of a computer system may be connected to a data storage device. A memory of the computer system may include the respective memory of each computing device of the plurality of computing devices.

FIG. 4 illustrates an implementation of a computer system that may execute techniques presented herein. The computer system 400 may include a set of instructions that can be executed to cause the computer system 400 to perform any one or more of the methods or computer based functions disclosed herein. The computer system 400 may operate as a standalone device or may be connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, “analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer,” a “computing machine,” a “computing platform,” a “computing device,” or a “server” may include one or more processors.

In a networked deployment, the computer system 400 may operate in the capacity of a server or as a client user computer in a server-client user network environment, or as a peer computer system in a peer-to-peer (or distributed) network environment. The computer system 400 can also be implemented as or incorporated into various devices, such as a personal computer (PC), a tablet PC, a Personal Digital Assistant (PDA), a mobile device, a palmtop computer, a laptop computer, a desktop computer, a web appliance, or any other machine capable of executing a set of instructions (sequential or otherwise) that specify actions to be taken by that machine. In a particular implementation, the computer system 400 may be implemented using electronic devices that provide voice, video, or data communication. Further, while the computer system 400 is illustrated as a single system, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a Central Processing Unit (CPU), a Graphics Processing Unit (GPU), or both. The processor 402 may be a component in a variety of systems. For example, the processor 402 may be part of a standard personal computer or a workstation. The processor 402 may be one or more processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e.,programmed).

The computer system 400 may include a memory 404 that can communicate via bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 404 may include a cache or random-access memory for the processor 402. In alternative implementations, the memory 404 is separate from the processor 402, such as a cache memory of a processor, the system memory, or other memory.

The memory 404 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the processor 402 executing the instructions stored in the memory 404. The functions, acts, or tasks are independent of the particular type of instruction set, storage media, processor or processing strategy and may be performed by software, hardware, integrated circuits, firmware, micro-code and the like, operating alone or in combination. Likewise, processing strategies may include multiprocessing, multitasking, parallel processing, and the like.

As shown, the computer system 400 may further include a display 410, such as a liquid crystal display (LCD), an organic light emitting diode (OLED), a flat panel display, a solid-state display, a cathode ray tube (CRT), a projector, a printer or other now known or later developed display device for outputting determined information. The display 410 may act as an interface for the user to see the functioning of the processor 402, or specifically as an interface with the software stored in the memory 404 or in the drive unit 406.

Additionally or alternatively, the computer system 400 may include an input/output device 412 configured to allow a user to interact with any of the components of the computer system 400. The input/output device 412 may be a number pad, a keyboard, or a cursor control device, such as a mouse, or a joystick, touch screen display, remote control, or any other device operative to interact with the computer system 400.

The computer system 400 may also or alternatively include drive unit 406 implemented as a disk or optical drive. The drive unit 406 may include a computer-readable medium 422 in which one or more sets of instructions 424, e.g., software, can be embedded. Further, instructions 424 may embody one or more of the methods or logic as described herein. The instructions 424 may reside completely or partially within the memory 404 and/or within the processor 402 during execution by the computer system 400. The memory 404 and the processor 402 also may include computer-readable media as discussed above.

In some systems, computer-readable medium 422 may include the set of instructions 424 or receive and execute the set of instructions 424 responsive to a propagated signal so that a device connected to network 430 can communicate voice, video, audio, images, or any other data over the network 430. Further, the set of instructions 424 may be transmitted or received over the network 430 via communication port or interface 420, and/or using bus 408. The communication port or interface 420 may be a part of the processor 402 or may be a separate component. The communication port or interface 420 may be created in software or may be a physical connection in hardware.

The communication port or interface 420 may be configured to connect with a network 430, external media, the display 410, or any other components in computer system 400, or combinations thereof. The connection with the network 430 may be a physical connection, such as a wired Ethernet connection or may be established wirelessly as discussed below. Likewise, the additional connections with other components of the computer system 400 may be physical connections or may be established wirelessly. The network 430 may alternatively be directly connected to the bus 408.

While the computer-readable medium 422 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that causes a computer system to perform any one or more of the methods or operations disclosed herein. The computer-readable medium 422 may be non-transitory, and may be tangible.

The computer-readable medium 422 may include a solid-state memory such as a memory card or other package that houses one or more non-volatile read-only memories. The computer-readable medium 422 can be a random-access memory or other volatile re-writable memory. Additionally or alternatively, the computer-readable medium 422 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations may broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

Computer system 400 may be connected to network 430. The network 430 may define one or more networks including wired or wireless networks. The wireless network may be a cellular telephone network, an 802.10, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 430 may include wide area networks (WAN), such as the Internet, local area networks (LAN), campus area networks, metropolitan area networks, a direct connection such as through a Universal Serial Bus (USB) port, or any other networks that may allow for data communication.

The network 430 may be configured to couple one computing device to another computing device to enable communication of data between the devices. The network 430 may generally be enabled to employ any form of machine-readable media for communicating information from one device to another. The network 430 may include communication methods by which information may travel between computing devices.

The network 430 may be divided into sub-networks. The sub-networks may allow access to all of the other components connected thereto or the sub-networks may restrict access between the components. The network 430 may be regarded as a public or private network connection and may include, for example, a virtual private network or an encryption or other security mechanism employed over the public Internet, or the like.

### Exemplary Embodiments

A computer-implemented method for providing temporary access to a remote database may be provided. The computer-implemented method may be performed by one or more local or remote processors of a computing system in communication with one or more local or remote data sources. The computer-implemented method may include (1) authenticating, via one or more processors, a user via a federated identity provider that enforces multi-factor authentication (MFA); (2) determining, via the one or more processors, a user access level based upon one or more user attributes received from the federated identity provider; (3) activating, via the one or more processors, a cloud service identity and access management (IAM) role corresponding to the user access level obtained from the federated identity provider; (4) dynamically generating, via the one or more processors, a set of temporary database credentials corresponding to the activated cloud service IAM role; and/or (5) establishing, via the one or more processors, a secure connection to the remote database using the set of temporary database credentials.

In some embodiments, the voice bots or chatbots may be configured to utilize AI and/or ML techniques, such as for input or output devices. For instance, a voice bot or chatbot may be a ChatGPT chatbot, an InstructGPT bot, a Codex bot, or a Google Bard bot. The voice bot or chatbot may employ supervised or unsupervised ML techniques, which may be followed by, and/or used in conjunction with, reinforced or reinforcement learning techniques. The voice bot or chatbot may employ the techniques utilized for ChatGPT, InstructGPT bot, Codex bot, or Google Bard bot.

Additionally or alternatively, the one or more user attributes may include one or more of (i) a group membership attribute, (ii) a role designation attribute, (iii) a security classification attribute, or (iv) an organizational unit designation attribute.

In certain aspects, the user access level may determine a set of database permissions assigned to the cloud service IAM role corresponding to the user access level.

In various embodiments, the set of temporary database credentials may be created via an automated script executing upon a user authentication.

In some embodiments, the automated script may be configured to interface with the remote database to generate the set of temporary database credentials with one or more predefined access permissions and expiration policies.

In various embodiments, the computer-implemented method may include (i) monitoring, via the one or more processors, user session activity in the remote database; (ii) identifying, via the one or more processors, an occurrence of a predetermined event; and/or (iii) based upon the identifying, revoking, via the one or more processors, the set of temporary database credentials.

In certain aspects, identifying the occurrence of the predetermined event may include identifying, via the one or more processors, that (i) a user activity has not been detected within a predetermined timeout interval, (ii) a predefined time-to-live (TTL) is reached, and/or (iii) a logout signal was initiated by the user or a system.

In some embodiments, revoking the set of temporary database credentials may trigger deprovisioning of one or more cloud resources created during the user session activity.

Additionally or alternatively, the cloud service IAM role may define one or more least-privilege access permissions to the remote database.

In certain aspects, the set of temporary database credentials may be encrypted during transmission from credential provisioning to a secure session interface.

In some embodiments, the computer-implemented method may include providing, via the one or more processors, the set of temporary database credentials to the secure session interface configured to establish a connection to the remote database.

A computer system for providing temporary access to a remote database may be provided. The computer system may include one or more processors of a computing system, and at least one non-transitory computer readable medium storing instructions which, when executed by the one or more processors, cause the one or more processors to perform operations. The computer system may perform operations including (1) authenticating a user via a federated identity provider that enforces MFA; (2) determining a user access level based upon one or more user attributes received from the federated identity provider; (3) activating a cloud service IAM role corresponding to the user access level obtained from the federated identity provider; (4) dynamically generating a set of temporary database credentials corresponding to the activated cloud service IAM role; and/or (5) establishing a secure connection to the remote database using the set of temporary database credentials.

Additionally or alternatively, the one or more user attributes may include one or more of (i) a group membership attribute, (ii) a role designation attribute, (iii) a security classification attribute, or (iv) an organizational unit designation attribute.

In certain aspects, the user access level may determine a set of database permissions assigned to the cloud service IAM role corresponding to the user access level.

In various embodiments, the set of temporary database credentials may be created via an automated script executing upon a user authentication.

In certain embodiments, the automated script may be configured to interface with the remote database to generate the set of temporary database credentials with one or more predefined access permissions and expiration policies.

In some embodiments, the computer-implemented method may include (i) monitoring user session activity in the remote database; (ii) identifying an occurrence of a predetermined event; and/or (iii) based upon the identifying, revoking the set of temporary database credentials.

A non-transitory computer readable medium for providing temporary access to a remote database may be provided. The non-transitory computer readable medium may store instructions which, when executed by one or more processors, cause the one or more processors to perform operations. The one or more processors may perform operations including (1) authenticating a user via a federated identity provider that enforces MFA; (2) determining a user access level based upon one or more user attributes received from the federated identity provider; (3) activating a cloud service IAM role corresponding to the user access level obtained from the federated identity provider; (4) dynamically generating a set of temporary database credentials corresponding to the activated cloud service IAM role; and/or (5) establishing a secure connection to the remote database using the set of temporary database credentials.

Additionally or alternatively, the one or more user attributes include one or more of (i) a group membership attribute, (ii) a role designation attribute, (iii) a security classification attribute, or (iv) an organizational unit designation attribute. The user access level may determine a set of database permissions assigned to the cloud service IAM role corresponding to the user access level.

In certain aspects, the set of temporary database credentials may be created via an automated script executing upon a user authentication. The automated script may be configured to interface with the remote database to generate the set of temporary database credentials with one or more predefined access permissions and expiration policies.

### Additional Considerations

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the actions, operations, and/or functionality of computer-implemented methods discussed are performed in one embodiment by an appropriate processor (or processors) of a processing (i.e.,computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

The present embodiments envision collecting and analyzing user or customer data, such as mobile device data associated with the user or customer devices or computing devices. Such data may be collected and analyzed once the user or customer affirmatively opts into a program, or the customer otherwise affirmatively consents to data being generated by their devices being utilized, collected, and/or analyzed.

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘_______’ is hereby defined to mean…” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Finally, unless a claim element is defined by expressly reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied upon a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate upon a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed is:

1. A computer-implemented method for providing temporary access to a remote database, comprising:
authenticating, via one or more processors, a user via a federated identity provider that enforces multi-factor authentication (MFA);
determining, via the one or more processors, a user access level based upon one or more user attributes received from the federated identity provider;
activating, via the one or more processors, a cloud service identity and access management (IAM) role corresponding to the user access level obtained from the federated identity provider;
dynamically generating, via the one or more processors, a set of temporary database credentials corresponding to the activated cloud service IAM role; and
establishing, via the one or more processors, a secure connection to the remote database using the set of temporary database credentials.

2. The computer-implemented method of claim 1, wherein the one or more user attributes include one or more of (i) a group membership attribute, (ii) a role designation attribute, (iii) a security classification attribute, or (iv) an organizational unit designation attribute.

3. The computer-implemented method of claim 1, wherein the user access level determines a set of database permissions assigned to the cloud service IAM role corresponding to the user access level.

4. The computer-implemented method of claim 1, wherein the set of temporary database credentials are created via an automated script executing upon a user authentication.

5. The computer-implemented method of claim 4, wherein the automated script is configured to interface with the remote database to generate the set of temporary database credentials with one or more predefined access permissions and expiration policies.

6. The computer-implemented method of claim 1, further comprising:
monitoring, via the one or more processors, user session activity in the remote database;
identifying, via the one or more processors, an occurrence of a predetermined event; and
based upon the identifying, revoking, via the one or more processors, the set of temporary database credentials.

7. The computer-implemented method of claim 6, wherein identifying the occurrence of the predetermined event comprises:
identifying, via the one or more processors, that (i) a user activity has not been detected within a predetermined timeout interval, (ii) a predefined time-to-live (TTL) is reached, or (iii) a logout signal was initiated by the user or a system.

8. The computer-implemented method of claim 6, wherein revoking the set of temporary database credentials triggers deprovisioning of one or more cloud resources created during the user session activity.

9. The computer-implemented method of claim 1, wherein the cloud service IAM role defines one or more least-privilege access permissions to the remote database.

10. The computer-implemented method of claim 1, wherein the set of temporary database credentials are encrypted during transmission from credential provisioning to a secure session interface.

11. The computer-implemented method of claim 10, further comprising:
providing, via the one or more processors, the set of temporary database credentials to the secure session interface configured to establish a connection to the remote database.

12. A computer system for providing temporary access to a remote database, comprising:
one or more processors of a computing system in communication with one or more data sources; and
at least one non-transitory computer readable medium storing instructions which, when executed by the one or more processors, cause the one or more processors to perform operations comprising:
authenticating a user via a federated identity provider that enforces multi-factor authentication (MFA);
determining a user access level based upon one or more user attributes received from the federated identity provider;
activating a cloud service identity and access management (IAM) role corresponding to the user access level obtained from the federated identity provider;
dynamically generating a set of temporary database credentials corresponding to the activated cloud service IAM role; and
establishing a secure connection to the remote database using the set of temporary database credentials.

13. The system of claim 12, wherein the one or more user attributes include one or more of (i) a group membership attribute, (ii) a role designation attribute, (iii) a security classification attribute, or (iv) an organizational unit designation attribute.

14. The system of claim 12, wherein the user access level determines a set of database permissions assigned to the cloud service IAM role corresponding to the user access level.

15. The system of claim 12, wherein the set of temporary database credentials are created via an automated script executing upon a user authentication.

16. The system of claim 15, wherein the automated script is configured to interface with the remote database to generate the set of temporary database credentials with one or more predefined access permissions and expiration policies.

17. The system of claim 12, further comprising:
monitoring user session activity in the remote database;
identifying an occurrence of a predetermined event; and
based upon the identifying, revoking the set of temporary database credentials.

18. A non-transitory computer readable medium for providing temporary access to a remote database, the non-transitory computer readable medium storing instructions which, when executed by one or more processors of a computing system in communication with one or more data sources, cause the one or more processors to perform operations comprising:
authenticating a user via a federated identity provider that enforces multi-factor authentication (MFA);
determining a user access level based upon one or more user attributes received from the federated identity provider;
activating a cloud service identity and access management (IAM) role corresponding to the user access level obtained from the federated identity provider;
dynamically generating a set of temporary database credentials corresponding to the activated cloud service IAM role; and
establishing a secure connection to the remote database using the set of temporary database credentials.

19. The non-transitory computer readable medium of claim 18, wherein the one or more user attributes include one or more of (i) a group membership attribute, (ii) a role designation attribute, (iii) a security classification attribute, or (iv) an organizational unit designation attribute; and wherein the user access level determines a set of database permissions assigned to the cloud service IAM role corresponding to the user access level.

20. The non-transitory computer readable medium of claim 18 wherein the set of temporary database credentials are created via an automated script executing upon a user authentication; and wherein the automated script is configured to interface with the remote database to generate the set of temporary database credentials with one or more predefined access permissions and expiration policies.
